(19) United States
(12) Patent Application Publication
(10) Pub. No.: US 2012/0092697 A1
(43) Pub. Date: Apr. 19, 2012

(54) IMAGE FORMING APPARATUS, IMAGE FORMING METHOD AND IMAGE FORMING SYSTEM

(75) Inventor: Kazuaki Kidokoro, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/273,584

(22) Filed: Oct. 14, 2011

Related U.S. Application Data
(60) Provisional application No. 61/394,572, filed on Oct. 19, 2010.

(51) Int. Cl. G06K 15/02; G06F 15/00

(52) U.S. Cl. 358/1.14; 358/1.15

(57) ABSTRACT

According to one embodiment, an image forming apparatus includes a control section configured to acquire job information including a type, quality, and a quantity of a job executed by the image forming apparatus, user information for specifying a user, and location information, which is address information of a server that executes a counter service for the user, calculate, from the acquired job information, a count value to be used in the image forming apparatus, display an input screen which presents the calculated count value to the user to urge the user to input executability of the job, execute the job when an input for instructing execution of the job is acquired, and transmit the calculated count value to the server.

### CROSS-REFERENCE TO RELATED APPLICATION

This application is based upon and claims the benefit of U.S. Provisional Application No. 61/394,572, filed on Oct. 19, 2010; the entire contents of which are incorporated herein by reference.

### FIELD

Embodiments described herein relate generally to an image forming apparatus such as an MFP (Multi-Function Peripheral), an image forming system in which the image forming apparatus and a server are connected via a network, and a control method for the image forming apparatus.

### BACKGROUND

As a form of an image forming apparatus, there is an apparatus called MFP (Multi-Function Peripheral). The MFP is a digital complex machine including plural functions such as a scanner function, a facsimile function, and an image data storing function in addition to a copying function.

In the past, in order to manage cost of using an image forming apparatus, counter management and quota management are used. The counter management is a system for managing cost using, as an index, a count of use of the image forming apparatus such as the number of prints or the number of times of copying in the image forming apparatus. The quota management is a management method for limiting the number of times of use of the image forming apparatus such as the number of prints or the number of times of copying in the image forming apparatus.

However, in the past, it is a general practice to incorporate procedures of the counter management and the quota management in the apparatus and use the procedures. Targets of application of the management are limited to use of apparatuses specified in advance in an organization. For example, the management is possible only when image forming apparatuses present in a predetermined office or building are used. Users who can use a certain image forming apparatus are limited to users in a predetermined company or users in a predetermined department.

On the other hand, according to the spread of mobile PCs (Personal Computers), portable terminals, and the like, image forming apparatuses outside organizations to which users belong such as those in print shops in towns and business trip destinations are more often temporarily used. Therefore, it is demanded that the counter management and the quota management can be performed even in such a case.

### BRIEF DESCRIPTION OF THE DRAWINGS

FIG. 1 is an exemplary diagram of the configuration of an image forming system according to an embodiment;

FIG. 2 is an exemplary diagram of an external configuration of an image forming apparatus according to the embodiment;

FIG. 3 is an exemplary diagram of the configuration of controls systems of apparatuses included in the image forming system according to the embodiment;

FIG. 4 is an exemplary flowchart for explaining an operation procedure performed when a client terminal causes the image forming apparatus to execute print according to the embodiment;

FIG. 5 is an exemplary flowchart for explaining an operation procedure performed when the image forming apparatus executes print according to the embodiment;

FIG. 6 is an exemplary flowchart for explaining an operation procedure performed when a counter and quota management server extracts the balance of use according to the embodiment;

FIG. 7 is an exemplary diagram of an executability check screen according to the embodiment; and

FIG. 8 is an exemplary flowchart for explaining an operation procedure performed when a user causes the image forming apparatus to execute copying, scanning, and facsimile.

### DETAILED DESCRIPTION

In general, according to one embodiment, an image forming apparatus connected to a server via a communication line includes a control section configured to acquire job information including a type, quality, and a quantity of a job executed by the image forming apparatus, user information for specifying a user, and location information, which is address information of a server that executes a counter service for the user, calculate, from the acquired job information, a count value to be used in the image forming apparatus, display an input screen presents the calculated count value to the user to urge the user to input executability of the job, execute the job when an input for instructing execution of the job is acquired, and transmit the scheduled count value to the server.

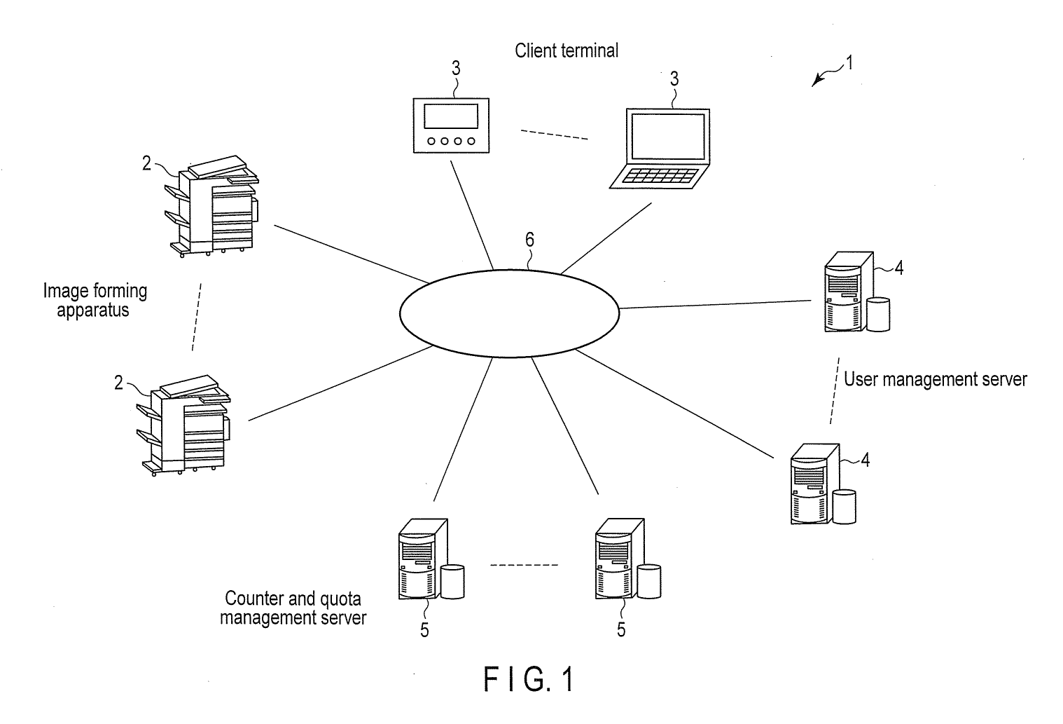

FIG. 1 is an exemplary diagram of the configuration of an image forming system according to an embodiment. An image forming system 1 includes at least one image forming apparatus 2, at least one client terminal 3, at least one user management server 4, and at least one counter and quota management server 5, which are connected via a communication line 6.

The image forming apparatus 2 is a digital complex machine called MFP. One image forming apparatus 2 includes plural functions such as functions of a copying machine, a scanner, a facsimile, and an image data recording function (a BOX function). Such image forming apparatuses are installed in companies, print shops, and the like all over the world.

The client terminal 3 is an information processing terminal owned by a user. The client terminal 3 can be desktop PC, a mobile PC (Personal Computer), a portable device, and the like.

The user management server 4 stores information concerning users. The counter and quota management server 5 executes counter management and quota management.

The communication line 6 is a path extensively used for transmission and reception of information. The communication line 6 is not limited to communication performed using wires such as a conductive wire and an optical fiber and may be wireless communication performed using light, a sound wave, a radio wave, and the like.

The user management server 4 and the counter and quota management server 5 can be configured as one server. In the following explanation, for simplification of the explanation, a form in which the user management server 4 and the counter and quota management server 5 are configured as one server is explained. However, when necessary, a form in which the user management server 4 and the counter and quota management server 5 are separated is referred to.

The counter and quota management server 5 may be configured as a counter management server configured to perform only the counter management. In the following explanation, the counter and quota management server 5 carries out the counter management and the quota management. However, when necessary, a form in which the counter and quota management server 5 performs only the counter management is referred to.

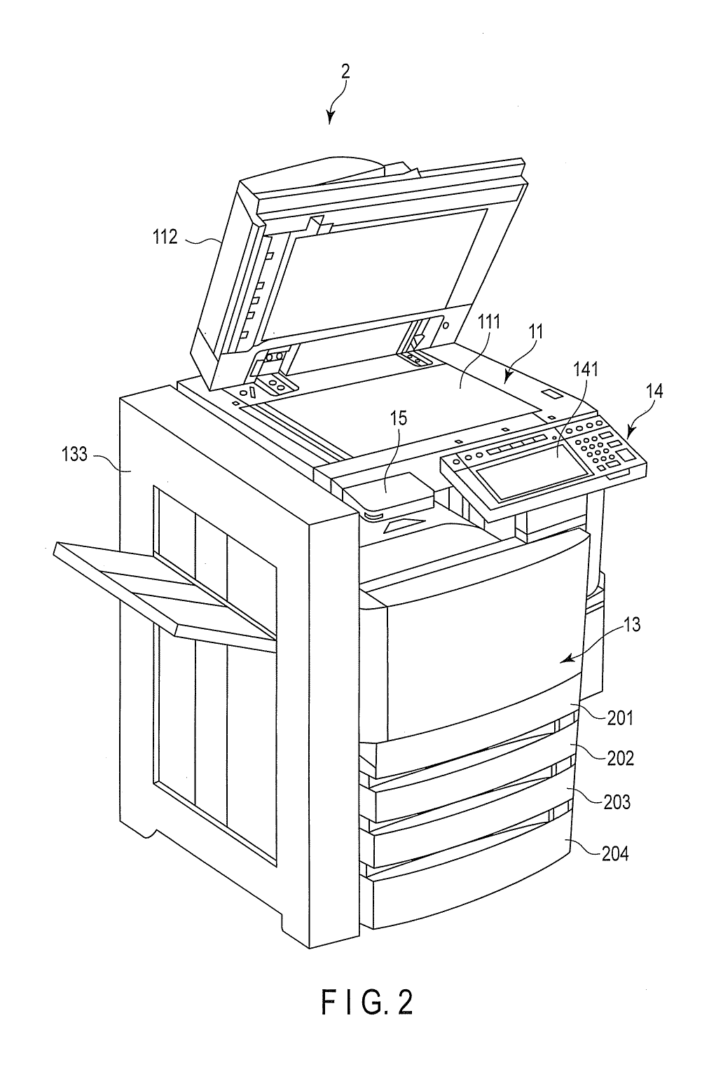

FIG. 2 is an exemplary diagram of an external configuration of the image forming apparatus according to the embodiment. The image forming apparatus 2 includes a scanner 11, a printer 13, a control panel 14, and a card reader 15.

The scanner 11 is set in an upper part of a main body of the image forming apparatus 2. The scanner 11 is an apparatus that optically reads an image of an original document. For example, the scanner 11 reads an image of an entire original document placed on a document table 111. The scanner 11 includes an auto document feeder (ADF) 112. The ADF 112 feeds sheet-like original documents one by one. The scanner 11 reads an image of the original document fed by the ADF 112.

The control panel 14 is set in a front part on the upper surface of the main body of the image forming apparatus 2. The control panel 14 displays guidance to a user and receives an instruction input from the user.

The control panel 14 includes various operation keys and various indicators. For example, a touch panel display 141 is provided in the control panel 14 as a display device incorporating a touch panel. In displaying various kinds of information or inputting information, the user touches an input field displayed on the touch panel display 141 or operates an operation key to input desired instruction content while checking information displayed on the touch panel display 141.

The card reader 15 is set in a front part on the upper surface of the main body of the image forming apparatus 2. The card reader 15 reads information stored in an ID card.

The printer 13 includes a paper feeding mechanism, a print mechanism, and a finishing mechanism. The paper feeding mechanism stores recording media serving as media on which images are formed. The paper feeding mechanism feeds the stored recording media to the print mechanism one by one. The print mechanism forms an image on the recording medium fed by the paper feeding mechanism. For example, as the print mechanism, various print systems such as an electrophotographic system, an inkjet system, and a thermal transfer system can be applied.

The printer 13 includes feeding cassettes 201, 202, 203, and 204. The feeding cassettes 201, 202, 203, and 204 store recording media to be subjected to print processing in the print mechanism.

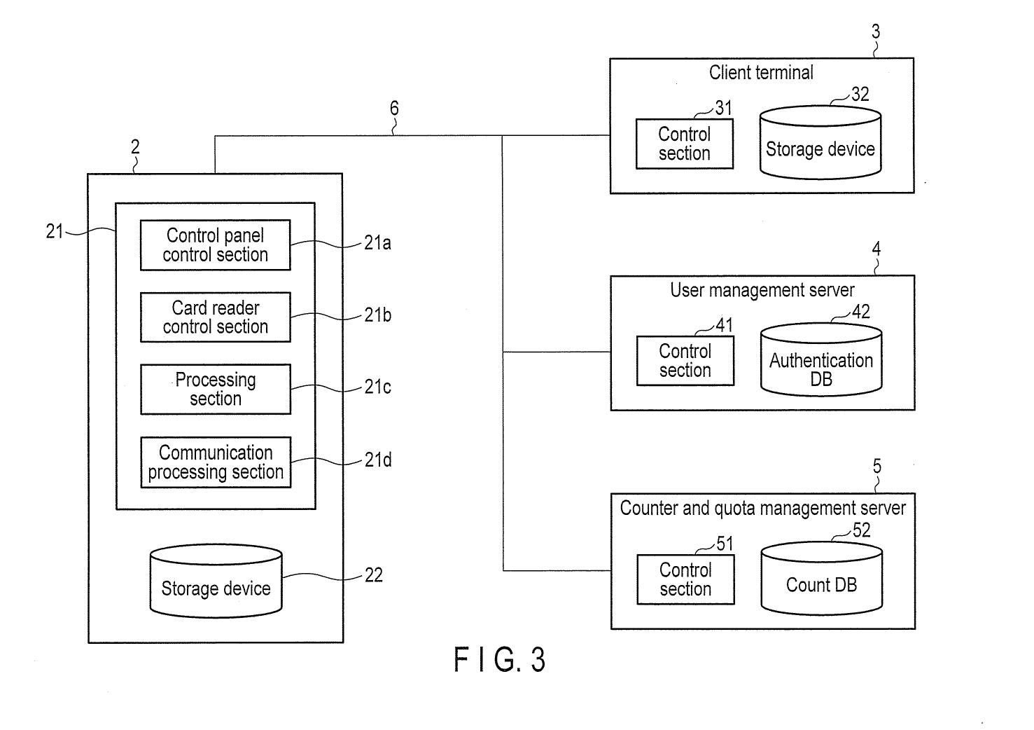

FIG. 3 is an exemplary diagram of the configuration of control systems of the apparatuses included in the image forming system according to the embodiment.

The image forming apparatus 2 includes a control section 21 and a storage device 22. The control section 21 collectively controls the operation of the image forming apparatus 2. The storage device 22 is a storage medium stored on the inside of the image forming apparatus 2. Image files, various kinds of setting information, and the like are stored in the storage device 22.

The control section 21 includes a control panel control section 21a, a card reader control section 21b, a processing section 21c, and a communication processing section 21d. The control panel control section 21a controls an operation for exchanging information between the control section 21 and the control panel 14. The card reader control section 21b controls the card reader 15 to read information from an ID card. The processing section 21c processes a job of the image forming apparatus 2 and executes processing concerning a counter service and a quota service. The communication processing section 21d controls information exchange via the communication line 6 among the client terminal 3, the user management server 4, and the counter and quota management server 5.

The client terminal 3 includes a control section 31 and a storage device 32. The control section 31 collectively controls the operation of the client terminal 3. The storage device 32 is a storage medium set on the inside of the client terminal 3. Information concerning a user, image files, and the like are stored in the storage device 32.

A print job is generated ad hoc by an application or the like and transmitted to the printer. The client terminal 3 manages only location information of the counter and quota management server 5 used by the user. In transmitting a job, the client terminal 3 transmits the server location information while incorporating the server location information in job information.

The user management server 4 includes a control section 41 and an authentication database (DB) 42. The control section 41 collectively controls the operation of the user management server 4. The authentication DB 42 is a storage medium set on the inside of the user management server 4. Authentication information of users is stored in the authentication DB 42. The control section 41 performs user authentication by determining whether authentication information transmitted from the image forming apparatus 2 and authentication information registered in the authentication DB 42 coincide with each other.

The counter and quota management server 5 includes a control section 51 and a count database (DB) 52. The control section 51 collectively controls the operation of the counter and quota management server 5. The count DB 52 is a storage medium set on the inside of the counter and quota management server 5. Information for performing count and the quota management for each user is stored in the count DB 52.

As explained above, in one case, the user management server 4 and the counter and quota management server 5 are the same server and, in the other case, the user management server 4 and the counter and quota management server 5 are separately mounted.

(1) If the user management server 4 and the counter and quota management server 5 are the same server, counter information and user information are managed together. Therefore, information “a user A uses count by X” transmitted from the printer can be collectively processed. Therefore, the image forming apparatus 2 only has to specify a location of the counter and quota management server 5.

(2) If the user management server 4 and the counter and quota management server 5 are separately mounted, the user management server 4 is present for each organization of users. Therefore, plural user management servers 4 can be present. The user management server 4 manages, for each user, information concerning which counter and quota management server 5 the user uses. The client terminal 3 transmits an address of the user management server 4 rather than an address of the counter and quota management server 5 while incorporating the address of the user management server 4 in job information. The image forming apparatus 2 inquires the user management server 4 about the address of the counter and quota management server 5 and specifies the address.

The operation of the image forming system according to this embodiment is explained below.

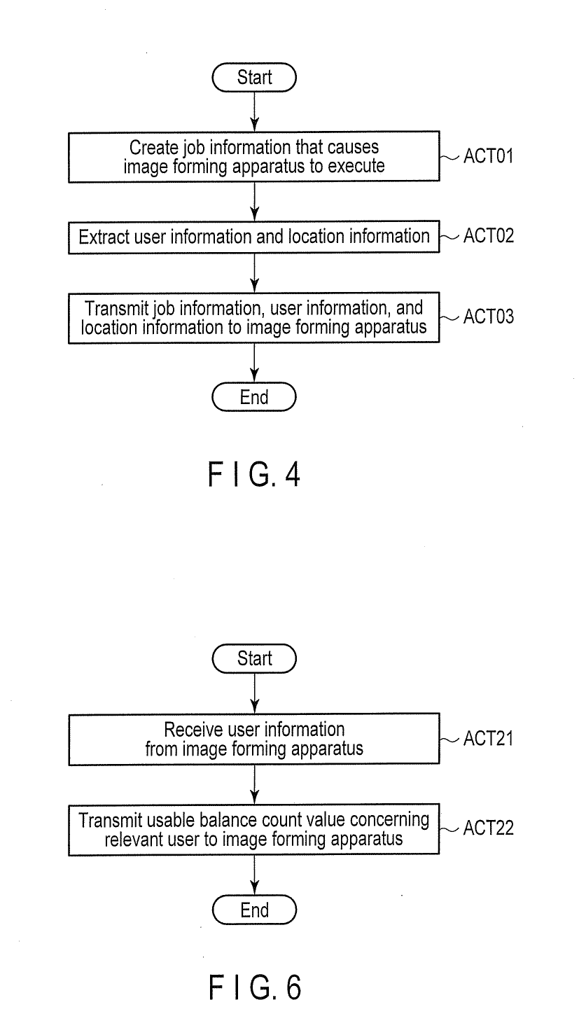

FIG. 4 is an exemplary flowchart for explaining an operation procedure performed when the client terminal causes the image forming apparatus to execute print according to the embodiment.

When the user inputs an instruction for print job execution to the client terminal 3, in Act 01, the control section 31 creates information concerning the print job that the control section 31 causes the image forming apparatus 2 to execute. In Act 02, the control section 31 extracts user information and location information of the counter and quota management server 5 from the job information.

The location information includes an address (e.g., URL: Uniform Resource Locator) of the counter and quota management server 5 that executes a counter service for the user. The user information includes information for specifying the user, for example, a user name and a password.

In Act 03, the control section 31 transmits the print job information, the user information, and the location information of the counter and quota management server 5 to the image forming apparatus 2. The control section 31 transmits the user information and the location information while incorporating the user information and the location information in the print job information. Therefore, a transmission protocol same as that used in the past can be used.

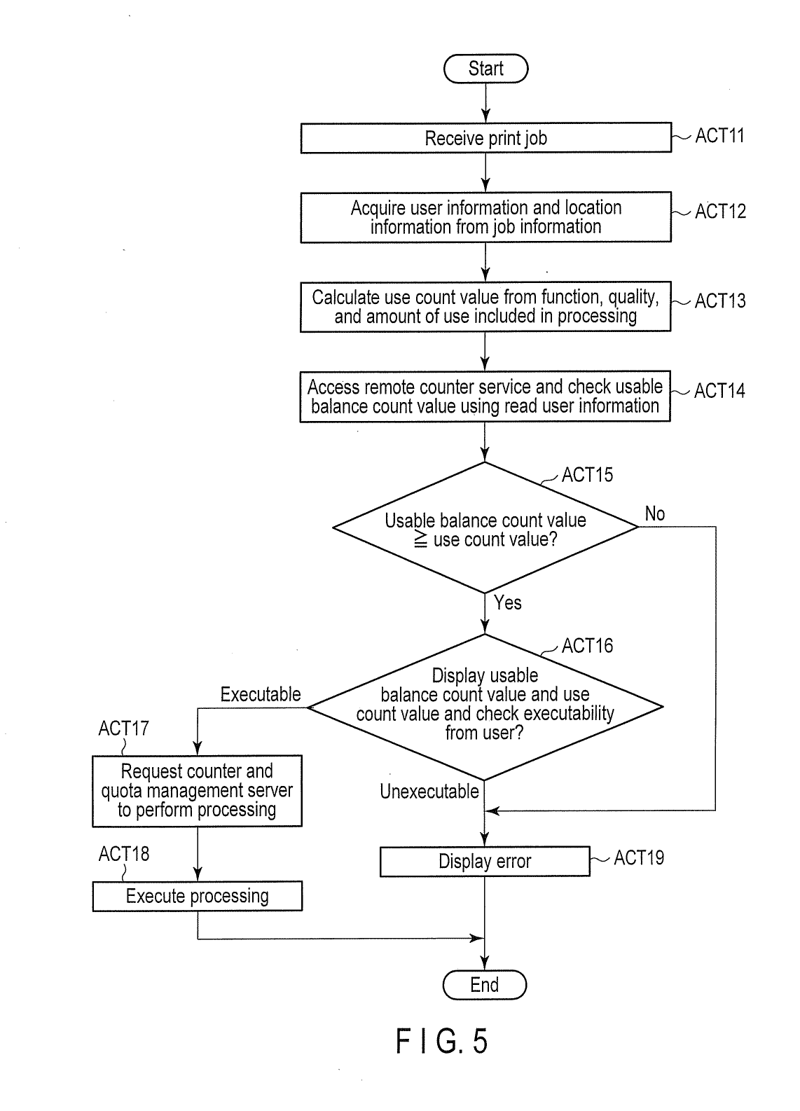

FIG. 5 is an exemplary flowchart for explaining an operation procedure performed when the image forming apparatus executes print according to the embodiment.

In Act 11, the processing section 21c receives the print job information from the client terminal 3 via the communication processing section 21d. In Act 12, the processing section 21c analyzes the print job information and acquires the user information and the location information of the counter and quota management server 5.

If the user management server 4 is separately provided, the location information included in the print job information is location information of the user management server 4. Therefore, the processing section 21c accesses the user management server 4 and acquires the location information of the counter and quota management server 5.

In Act 13, the processing section 21c extracts “function”, “quality”, and “amount of use” included in the received information. The “function” represents a type of an operation executed by the image forming apparatus 2 and is, for example, “print of the A4 size”. The “quality” represents a type of print and is, for example, “color” or “monochrome”. The “amount of use” represents, for example, “number of prints” of print.

The processing section 21c calculates a use count value using these data. The use count value is represented by, for example, Formula (1).

Use count value=“function”×“quality”×“amount of use” Formula (1)

A unit value for calculating the use count value is stored in the storage device 22 of the image forming apparatus 2. For example, “print of the A4 size”=10 and “color”=2 are stored. If the “amount of use” is the number of prints=5, from Formula (1), the use count value is calculated as 100 (=10×2×5).

In this way, the unit value for calculating the use count value is stored for each image forming apparatus 2. Therefore, it is possible to calculate a use count value corresponding to a charge system of the image forming apparatus 2.

In Act 14, the processing section 21c transmits the user information to the counter and quota management server 5 specified by the location information via the communication processing section 21d. The processing section 21c acquires “usable balance” of the relevant user from the counter and quota management server 5.

FIG. 6 is an exemplary flowchart for explaining an operation procedure performed when the counter and quota management server extracts the balance of use according to the embodiment.

In Act 21, the control section 51 receives the user information from the image forming apparatus 2. In Act 22, the control section 51 searches through the count DB 52 on the basis of the user information. In the count DB 52, a count total value and a usable balance count value are provided for each user. However, in some case, depending on a user, the quota management is not carried out and no limit is provided for a count value. In that case, information indicating that no limit is provided is stored in the count DB 52. The control section 51 transmits the extracted usable balance count value to the image forming apparatus 2. If no limit is provided for the count value, the control section 51 sets the usable balance count value to the maximum and transmits the usable balance count value to the image forming apparatus 2.

In Act 15 in FIG. 5, the processing section 21c compares the usable balance count value received from the counter and quota management server 5 and the use count value calculated by the processing section 21c.

If the usable balance count value is equal to or larger than the use count value (Yes in Act 15), in Act 16, the processing section 21c displays the usable balance count value and the use count value on the control panel 14 and checks possibility of execution of processing.

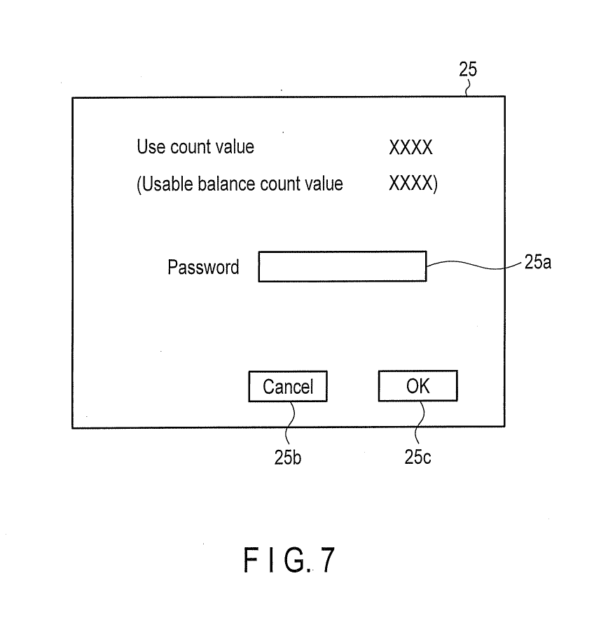

FIG. 7 is an exemplary diagram of an executability check screen according to the embodiment.

The use count value and the usable balance count value are displayed on an executability check screen 25. A password input space 25a, a cancel button 25b, and an OK button 25c are provided on the executability check screen 25. The user determines executability of processing referring to the displayed use count value and usable balance count value.

The password input space 25a is provided to prevent the client terminal 3 from being used by others without permission. If the OK button 25c is operated, the processing section 21c compares a password input from the executability check screen 25 and a password input by the user information. If the passwords coincide with each other, the processing section 21c executes processing explained below.

In order to further improve security, first and second passwords may be set for the user information and the password input from the executability check screen 25 may be the second password different from the first password used in authentication. In this case, the client terminal 3 transmits the first and second passwords while including the first and second passwords in the user information.

If the counter management is carried out and the quota management is not carried out, the usable balance count value does not have to be displayed on the executability check screen shown in FIG. 7. In this case, the processing section 21c does not execute Acts 14 and 15. In Act 16, the processing section 21c displays the use count value on the control panel 14 and checks possibility of execution of processing.

If the user operates the OK button 25c (executable in Act 16), in Act 17, the processing section 21c transmits a count processing request including the user information and the use count value to the counter and quota management server 5. In Act 18, the processing section 21c executes designated print processing.

If the counter and quota management server 5 receives the count processing request, the counter and quota management server 5 adds, concerning the relevant user, the transmitted count value to the count total value provided in the count DB 52 and subtracts the transmitted count value from the usable balance count value. If the counter management is carried out and the quota management is not carried out, the counter and quota management server 5 executes only processing for adding the transmitted count value to the count total value provided in the count DB 52.

If the usable balance count value is smaller than the use count value (No in Act 15), in Act 19, the processing section 21c displays an error message to the effect that the usable balance count value is smaller than the use count value and the image forming apparatus 2 cannot be used and ends the operation. If the user operates the cancel button 25b (No in Act 16), in Act 19, the processing section 21c displays an error message to the effect that processing is not executed and ends the operation.

The executability check screen 25 and the error messages may be displayed either on the control panel 14 or the client terminal 3.

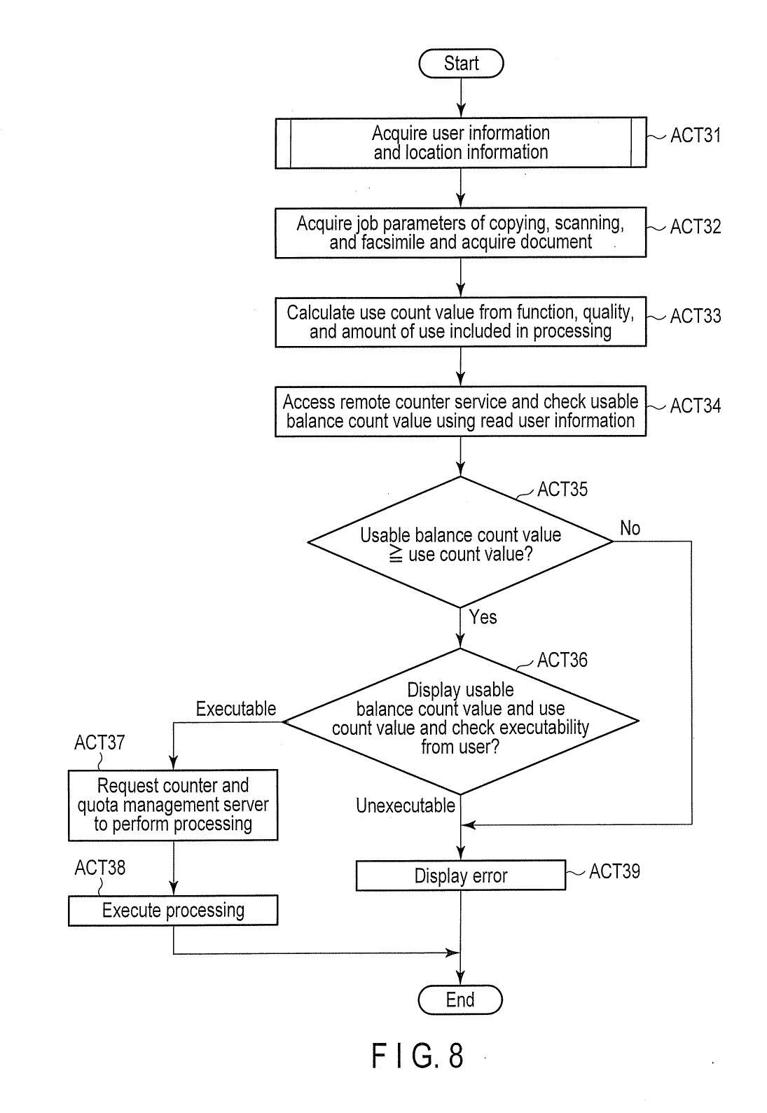

FIG. 8 is an exemplary flowchart for explaining an operation procedure performed when the user causes the image forming apparatus to execute copying, scanning, and facsimile according to the embodiment.

Before starting processing, the user inputs user information and location information of a counter service. The location information is a transmission address of a server that executes the counter service for the user. The user information includes information for specifying the user, for example, a user name and a password.

In Act 31, the image forming apparatus 2 acquires the user information and the location information. There are forms explained below as a method in which the user inputs these kinds of information.

(1) The user directly inputs the user information and the location information from the control panel 14. The location information is a transmission address of the counter and quota management server 5.

(2) The user inputs the user information and the location information stored in an ID card or the like of the user via the card reader 15. The location information is the transmission address of the counter and quota management server 5.

If the user management server 4 and the counter and quota management server 5 are separately provided, the location information to be acquired is the location information of the user management server 4. The image forming apparatus 2 transmits the user information to the user management server 4 to cause the user management server 4 to authenticate the user and acquires the transmission address of the counter and quota management server 5.

In Act 32, the processing section 21c acquires a type of a job such as a copy, scan, or facsimile job input by the user from the control panel 14, parameters for executing the job, and a document.

In Act 33, the processing section 21c extracts “function”, “quality”, and “amount of use” included in the received information. The “function” represents a type of an operation executed by the image forming apparatus 2 and is, for example, “copying”, “scanning”, or “facsimile”. The “quality” represents a type of the operation and is, for example, “color” or “monochrome”. The “amount of use” is, for example, “number of copies” of copying.

The processing section 21c calculates a use count value using these data. Since the use count value is explained concerning Formula (1), redundant explanation of the use count value is omitted.

In Act 34, the processing section 21c transmits, via the communication processing section 21d, the user information to the counter and quota management server 5 specified by the location information. The processing section 21c acquires “usable balance” of the relevant user from the counter and quota management server 5.

Since the operation of the counter and quota management server 5 is the same as the operation of the flow shown in FIG. 6, redundant explanation of the operation is omitted.

In Act 35, the processing section 21c compares the usable balance count value received from the counter and quota management server 5 and the use count value calculated by the processing section 21c.

If the usable balance count value is equal to or larger than the use count value (Yes in Act 35), in Act 36, the processing section 21c displays the usable balance count value and the use count value on the control panel 14 and checks possibility of execution of processing.

Since an executability check screen is the same as the screen shown in FIG. 7, redundant explanation of the executability check screen is omitted.

If the counter management is carried out and the quota management is not carried out, the usable balance count value does not have to be displayed on the usability check screen shown in FIG. 7. In this case, the processing section 21c does not execute Acts 34 and 35 and, in Act 36, the processing section 21c displays the use count value on the control panel 14 and checks possibility of execution of processing.

If the user operates the OK button 25c (executable in Act 36), in Act 37, the processing section 21c transmits a count processing request including the user information and the use count value to the counter and quota management server 5. In Act 38, the processing section 21c executes designated processing.

If the counter and quota management server 5 receives the count processing request, the counter and quota management server 5 adds, concerning the relevant user, the transmitted count value to the count total value provided in the count DB 52 and subtracts the transmitted count value from the usable balance count value. If the counter management is carried out and the quota management is not carried out, the counter and quota management server 5 executes only processing for adding the transmitted count value to the count total value provided in the count DB 52.

If the usable balance count value is smaller than the use count value (No in Act 35), in Act 39, the processing section 21c displays, on the control panel 14, an error message to the effect that the usable balance count value is smaller than the use count value and the image forming apparatus 2 cannot be used and ends the operation. If the user operates the cancel button 25b (No in Act 36), in Act 39, the processing section 21c displays, on the control panel 14, an error message to the effect that processing is not executed and ends the operation.

According to the embodiment explained above, the image forming apparatus can perform counter and quota processing without having information concerning counter and quota services used by the user. Even if the user temporarily uses an image forming apparatus in which the user is not registered, the user can perform document processing without performing a complicated procedure. Further, the user can use a centralized accounting service irrespective of a place of use and an image forming apparatus in use.

The functions explained in the embodiment may be configured using hardware or may be realized by causing a computer to read a computer program describing the functions using software. The functions may be configured by selecting the software or the hardware as appropriate.

Further, the functions can also be realized by causing the computer to read a computer program stored in a not-shown recording medium. A recording form of the recording medium in this embodiment may be any form as long as the recording medium can record the computer program and is readable by the computer.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus connected to a server via a communication line, the image forming apparatus comprising:
a control section configured to
acquire job information including a type, quality, and a quantity of a job executed by the image forming apparatus, user information for specifying a user, and location information, which is address information of a server that executes a counter service for the user,
calculate, from the acquired job information, a count value to be used in the image forming apparatus,
display an input screen which presents the calculated count value to the user to urge the user to input executability of the job,
execute the job when an input for instructing execution of the job is acquired, and
transmit the scheduled count value to the server.

2. The apparatus according to claim 1, wherein
the user information includes a password,
an input field for inputting the executability of the job and an input field for inputting the password are provided on the input screen, and
the control section executes the job if the password acquired on the input screen and the password of the user information coincide with each other when the input for instructing the execution of the job is acquired.

3. The apparatus according to claim 1, wherein
the user information includes first and second passwords,
an input field for inputting the executability of the job and an input field for inputting the password are provided on the input screen, and
the control section executes the job if the password acquired on the input screen and the second password of the user information coincide with each other when the input for instructing the execution of the job is acquired.

4. The apparatus according to claim 1, wherein
the calculated count value is calculated from values obtained by multiplying unit prices respectively corresponding to items including the type, the quality, and the quantity of the job of the job information, and
the unit prices are set for each the image forming apparatus.

5. The apparatus according to claim 1, wherein
the type of the job information is print, and
the information acquiring section acquires the job information, the user information, and the location information from a client terminal connected to the communication line.

6. The apparatus according to claim 5, wherein
the communication line is a wireless communication line, and
the client terminal is a portable information processing terminal.

7. The apparatus according to claim 1, wherein the control section transmits a request command for requesting a usable balance count value concerning the user to the server, determines executability of the job from comparison of the usable balance count value transmitted from the server and the calculated count value, and additionally presents the usable balance count value on the input screen if it is determined that the execution of the job is possible.

8. The apparatus according to claim 7, wherein
the user information includes a password,
an input field for inputting the executability of the job and an input field for inputting the password are provided on the input screen, and
the control section executes the job if the password acquired on the input screen and the password of the user information coincide with each other when the input for instructing the execution of the job is acquired.

9. The apparatus according to claim 7, wherein
the user information includes first and second passwords,
an input field for inputting the executability of the job and an input field for inputting the password are provided on the input screen, and
the control section executes the job if the password acquired on the input screen and the second password of the user information coincide with each other when the input for instructing the execution of the job is acquired.

10. The apparatus according to claim 7, wherein
the calculated count value is calculated from values obtained by multiplying unit prices respectively corresponding to items including the type, the quality, and the quantity of the job of the job information, and
the unit prices are set for each the image forming apparatus.

11. The apparatus according to claim 1, wherein
the type of the job information is copying, scanning, or facsimile, and
the information acquiring section acquires the job information, the user information, and the location information via a control panel provided in the image forming apparatus.

12. The apparatus according to claim 11, wherein
the user information includes a password,
an input field for inputting the executability of the job and an input field for inputting the password are provided on the input screen, and
the control section executes the job if the password acquired on the input screen and the password of the user information coincide with each other when the input for instructing the execution of the job is acquired.

13. The apparatus according to claim 11, wherein
the user information includes first and second passwords,
an input field for inputting the executability of the job and an input field for inputting the password are provided on the input screen, and
the control section executes the job if the password acquired on the input screen and the second password of the user information coincide with each other when the input for instructing the execution of the job is acquired.

14. The apparatus according to claim 11, wherein the control section transmits a request command for requesting a usable balance count value concerning the user to the server, determines executability of the job from comparison of the usable balance count value transmitted from the server and the calculated count value, and additionally presents the usable balance count value on the input screen if it is determined that the execution of the job is possible.

15. The apparatus according to claim 1, wherein
the type of the job information is copying, scanning, or facsimile, and
the information acquiring section acquires the job information via a control panel provided in the image forming apparatus and acquires the user information and the location information via a card reader provided in the image forming apparatus.

16. The apparatus according to claim 15, wherein
the user information includes a password,
an input field for inputting the executability of the job and an input field for inputting the password are provided on the input screen, and
the control section executes the job if the password acquired on the input screen and the password of the user information coincide with each other when the input for instructing the execution of the job is acquired.

17. The apparatus according to claim 15, wherein
the user information includes first and second passwords,
an input field for inputting the executability of the job and an input field for inputting the password are provided on the input screen, and
the control section executes the job if the password acquired on the input screen and the second password of the user information coincide with each other when the input for instructing the execution of the job is acquired.

18. The apparatus according to claim 15, wherein the control section transmits a request command for requesting a usable balance count value concerning the user to the server, determines executability of the job from comparison of the usable balance count value transmitted from the server and the calculated count value, and additionally presents the usable balance count value on the input screen if it is determined that the execution of the job is possible.

19. An image forming system comprising:
an image forming apparatus; and
a server connected to the image forming apparatus via a communication line, wherein
the image forming apparatus includes a control section configured to acquire job information including a type, quality, and a quantity of a job executed by the image forming apparatus, user information for specifying a user, and location information, which is address information of a server that executes a counter service for the user, calculate, from the acquired job information, a count value to be used in the image forming apparatus, display an input screen which presents the calculated count value to the user to urge the user to input executability of the job, execute the job when an input for instructing execution of the job is acquired, and transmit the calculated count value to the server, and
the server includes a processing section configured to subtract the calculated count value from a usable balance count value concerning the user when the calculated count value is received.

20. An image forming method for an image forming apparatus connected to a server via a communication line, the image forming method comprising:
acquiring job information including a type, quality, and a quantity of a job executed by the image forming apparatus, user information for specifying a user, and location information, which is address information of a server that executes a counter service for the user;
calculating, from the acquired job information, a count value to be used in the image forming apparatus;
displaying an input screen which presents the calculated count value to the user to urge the user to input executability of the job; and
executing the job when an input for instructing execution of the job is acquired and transmitting the calculated count value to the server.
